(19) United States
(12) Patent Application Publication
(10) Pub. No.: US 2006/0088047 A1
(43) Pub. Date: Apr. 27, 2006

(54) Method and apparatus for establishing connections in distributed computing systems

(76) Inventor: Rossen P. Dimitrov, Nashua, NH (US)

Correspondence Address: DUCKOR SPRADLING METZGER, 401 WEST A STREET, SUITE 2400, SAN DIEGO, CA, 92101-7915, US

(21) Appl. No.: 10/973,538

(22) Filed: Oct. 26, 2004

(51) Int. Cl. H04J 3/16

(52) U.S. Cl. 370/437

(57) ABSTRACT

A method and apparatus are disclosed for establishing connections in a distributed computing system to execute a job having a group of processes. Connection acceptors associated individually with each process wait for on demand connection requests. A determination is made whether a connection is already established between a sender process and a receiver process. If none exists, the connection acceptor receives the new connection on demand request associated with the receiver process. The requested new connection is established to facilitate the processes. Other connections between other processes may also be established for completing the job.

### FIELD OF THE INVENTION

The present invention in general relates to a method and apparatus for establishing connections in distributed computing systems. It more particularly relates to such a method and apparatus to facilitate expansion of such computing systems.

### BACKGROUND ART

There is no admission that the background art disclosed in this section legally constitutes prior art.

The size of distributed high performance computing (HPC) systems used for running large parallel jobs is continuously growing. Scalability bottlenecks in software and the communication infrastructure (network hardware and transport protocols) are often impediments for running efficient parallel jobs on large computer clusters. Connection oriented protocols require allocation of resources for each connection a particular node in the cluster establishes to any other node. These resources include memory and software objects maintained by the operating systems, such as file descriptors and ports.

With growing the number of nodes in the computer cluster, the number of connections to be established for each node also grows, and along with that the resources allocated for these connections. When the number of nodes in a computer cluster reaches a sufficiently large number such as several thousands, the memory allocated for the connections can occupy a significant portion of the overall system memory and thus reduce the available memory for the application algorithm and the remaining operating system services. Thus, for some applications, the overall performance may become degraded. Also, the operating system allocates internal software objects for each connection. When many connections are established, the operating system in certain circumstances may run out of such resources and subsequently refuse or be unable to efficiently establish new connections, thus limiting the scalability of the parallel jobs and the effectiveness of the parallel system as a whole.

Frequently, message passing systems for parallel processing are based on the peer-to-peer communication model, as opposed to the client-server model on which are based many of the Internet services and common database management systems. In the client-server model, clients usually communicate only with the server and not among themselves. In the peer-to-peer model, it is the usual situation where every process of the parallel job can communicate with any other process in the job. Whether communication operations between any two nodes may take place or not depends on the actual user algorithm that uses the message passing system, but the message passing system generally has no way of knowing this in advance. Thus, many connections and associated resources may be dedicated to a job, depending on the actual requirements of the application, when they may not all be required by the application.

In recent years, new high-speed networks with specialized software interfaces and transport protocols have been used to alleviate the scalability limitations of general purpose networks, such as Ethernet with connection oriented transports, such as TCP/IP. These high-speed networks, such as Myrinet and others, provide a number of special features that provide higher communication performance and also increased scalability. Although the high-speed networks solve many of the performance and scalability problems of large computer clusters, because they are very expensive, they have not been commonly accepted in the area of HPC cluster computing for some applications. The cost of the high-speed network in a large computer cluster can exceed a significant percentage such as 30% or more of the total system cost. Consequently, HPC clusters are presently largely being built using Ethernet (100 Mbps or Gigabit) with the TCP/IP transport protocol for many applications.

At least some conventional message-passing systems that work with connection-oriented transports establish connections between each pair of processes in order to ensure the requirement for global connectivity among the processes of a single job. These connections are established during the initialization phase of the message passing system. When such a message passing system is used on a large-scale computer cluster, it may result in the creation of an excessive number of connections on each node. With increasing the size of the jobs, this may, under certain circumstances, lead to resource exhaustion, ultimately limiting the scalability of the whole computation system.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a block diagram of a distributed computing system, which is constructed according to an embodiment of the invention;

FIG. 2 is a block diagram of a portion of the system of FIG. 1, illustrating other computer nodes, not shown in FIG. 1, in the process of communicating via various connections therebetween;

FIG. 3 is a block diagram of a portion of the system of FIG. 1, illustrating the way in which a communication connection is established between two processes;

FIG. 4 is a flow chart diagram illustrating a sender protocol for establishing connections on demand in the system of FIG. 1; and

FIG. 5 is a flow chart diagram illustrating a receiver protocol for establishing connections on demand in the system of FIG. 1.

### DETAILED DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of the embodiment of the invention.

A method and apparatus are disclosed for establishing connections in a distributed computing system to execute a job having a group of processes. Connection acceptors associated individually with each process wait for on demand connection requests. A determination is made whether a connection is already established between a sender process and a receiver process. If none exists, the connection acceptor receives the new connection on demand request associated with the receiver process. The requested new connection is established to facilitate the processes. Other connections between other processes may also be established for completing the job.

One aspect of the disclosed embodiments of the invention is to postpone the creation of communication connections in certain circumstances between the processes that belong to a single job until the time when these connections are actually needed for communication transactions as requested by the application algorithm. Thus, unnecessary connections and their associated resources are not dedicated to a particular job being run. This mechanism may be referred to as “connections on demand”. Connections are created only between processes that exchange messages. If the application algorithm does not exchange messages between some pair of processes, the “connections on demand” mechanism may not establish a connection between these two processes.

Many parallel applications may use algorithms that cause processes to communicate with a small sub-set of all of the remaining processes in the parallel jobs under some circumstances. An example of such algorithms are Computational Fluid Dynamics algorithms that solve large problems by dividing the problem among multiple processes. Each of these processes communicates only with processes that work on adjacent pieces of the large problem.

The “connections on demand” mechanism reduces greatly the number of effectively created and maintained connections for many parallel algorithms in used today. As a result, these applications when executed with a message passing system implementing an embodiment of the invention may be able to scale to much larger sizes, which may not otherwise be achieved by conventional message passing systems without the “connections on demand mechanism” in at least some circumstances.

During the initialization part of the message passing system with support for “connections on demand”, information about the end points of the connections needed for communication between each pair of processes may be exchanged. This information may be distributed to each process and stored in this process' memory space. Connections between the end points of the processes are not created during the initialization phase. The connection creation is postponed until the moment when a particular connection is necessary for transmitting a message requested by the application algorithm. Depending on the particular application and environment, once a connection is created on demand, it may either be kept until the end of the job, or destroyed. Applications with static pattern of connections and repeatable communication requests over the same connection may benefit from keeping the connection opened. Since establishing new connections may be a relatively high overhead operation, keeping the connections open for subsequent communications may avoid this overhead and improve performance under certain circumstances. The disclosed embodiments of the invention relate to the process of adaptive or dynamic connection creation, but the decision whether the connections are kept open or destroyed immediately after the communication transaction finishes, is beyond the scope of the disclosed embodiments of the invention.

The message passing software systems of the disclosed embodiments of the invention may provide communication infrastructure for exchanging messages among processes that execute a distributed application. The generic software architecture may include an application thread, which performs the application specific processing and a communication or progress thread that performs the communication operations. Depending on the architecture of the message passing system, the communication thread may be the same as the application thread or a separate system thread maintained by the message passing system. The application thread may interact with the communication thread through synchronization primitives, which may indicate when a message is sent or received. This synchronization may be necessary to ensure integrity of the message transfers under certain circumstances.

The communication thread may receive messages from other processes through connections established to these processes. Each process may have a connection descriptor associated with each connection. The connection descriptors may be maintained in an array, which may be used for checking whether new messages arrive. Different message passing systems may chose to use a method for continuous polling of these connections for new message arrivals or use specific software mechanisms for aggregating the connections. The latter approach allows the message passing system to reduce the number of polls, which in turn reduces the processor overhead. Also, if the communication thread is distinct from the application thread, using the aggregation mechanism the communication thread may be able to sleep until a new message arrives. This may further reduce the waste of processor time on communication activities under certain circumstances.

The disclosed embodiments of the invention use a connection acceptor in the form of a special purpose system thread, which accepts requests for creation of new connections between processes that need to communicate according to the application algorithm. This thread is referred to herein as an “accept thread”. This thread may be distinct from the communication thread, or it may be the same thread.

The message passing system with support for “connections on demand” may complete its initialization phase without creation of any connections. As a result, the array of connection descriptors used by the communication thread may be empty.

When a process requests a message to be transferred to another destination process, the message passing system checks if a connection to the destination node is already established. If it is not, the sender process sends or initiates a connection creation request with the destination process. The accept thread on the destination process may accept the request and may complete the connection creation. Then, the accept thread of the receiver process and the sending process enter a handshake procedure that is intended to avoid race conditions which might arise in a situation when both processes attempt to initiate connections simultaneously. The procedure ensures that only one of the possible concurrent requests succeeds. The other request may be rejected. Once the procedure for race condition avoidance completes, both processes add the new connection descriptor to their array of active connections. Thus, the communication thread may be able to send and/or receive messages on this connection.

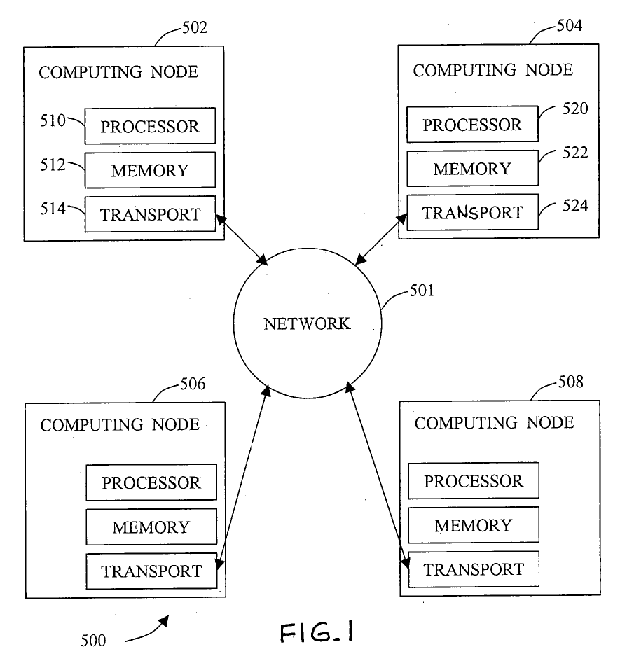

Referring now to the drawings and more particularly to FIG. 1 thereof, there is shown a networked distributed computing system 500, which is constructed according to an embodiment of the invention. The network 501 connects computing nodes 502, 504, 506, and 508, as well as others (not shown in FIG. 1). A TRANSPORT protocol may be used, and is referred to as CONNECTION-ORIENTED TRANSPORT PROTOCOL. However, other protocols may also be used.

The computing nodes may be similar to one another. For example, the node 502 may include a processor 410, a memory 512 and a transport 514 for communicating with other nodes via the network 501. Similarly, for example, node 504 includes a processor 520, a memory 522 and a transport 524 for communication purposes.

It should be understood that the system 500 is a distributed computing system having a group of nodes. The nodes can be distributed geographically, or can be disposed in close proximity, such as on the same circuit board, or any combination thereof.

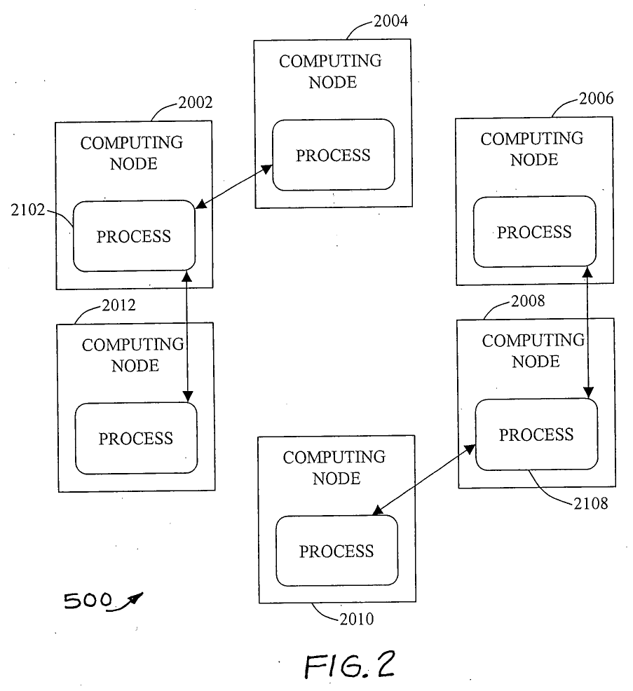

Referring now to FIG. 2, there is shown six additional computing nodes of the system 500. Each node executes one process, all belonging to a single distributed application using communication middleware constructed according to an embodiment of the invention. An example of an application that requires communication only between neighboring nodes is shown. Two computing nodes 2002 and 2008 with respective processes 2102 and 2108 are specifically shown with their connections. Each of the 2102 and 2108 processes makes connection only to its neighboring processes in the job resulting in only two connections per process. The saving is of several connections such as three connections for each node. For a larger system with a large number of nodes and processes of the distributed job, the saving in connections and resources allocated for these connections may even be greater. For example, for a system with 1024 nodes running a 1024-process distributed job, the saving may be of 1021 connections (two when the invention is used and 1023 when it is not used according to prior known techniques) under certain circumstances.

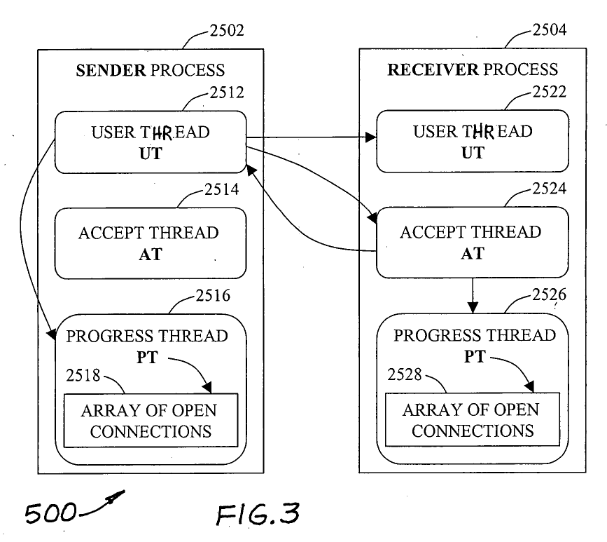

Referring now to FIG. 3, there is shown the structure and interactions between the software components of a sender process 2502 and a receiver process 2504 that participate in a communication operation that requires the creation of a connection on demand. FIG. 3 shows the sequence of actions that take place after a request for communication is received, leading to the creation of a connection on demand. It should be understood that the sender and receiver processes 2502 and 2504 may take place in the nodes of the system 500.

The user thread 2512 of the sender process 2502 initiates a communication operation to the user thread 2522 of the receiver process 2504. Before the communication operation can be performed, a connection on demand between the two processes may need to be established. The sender's user thread 2512 sends a request for a new connection to receiver's accept thread 2524. Receiver's accept thread accepts the requests, which leads to the creation of the requested connection between the two communicating processes. Once the connection is accepted by the receiver's accept thread, the accept thread informs receiver's communication or progress thread 2526 about the availability of a new connection. Receiver's progress thread in turn adds the new connection to the array of open connections 2528. Similarly to the receiver, after the sender's request for a new connection succeeds, sender's user thread 2512 informs sender's progress thread 2516 about the new connection, which is added by sender's thread 2516 to sender's array of open connections 2518. Once the new connection is added to the arrays of open connections in both the sender and receiver processes, the communication operation requested by the sender's user thread can be executed as specified.

A sender or a sender process is a process of a peer-to-peer distributed application that executes a send operation, which may result in a connection on demand request. A receiver or a receiver process is a process of a peer-to-peer distributed application that may or may not execute a receive operation, and which may accept the connection on demand request from the sender. A user thread UT is the thread that executes the application code. A progress thread PT is a system thread which may be used by the communication middleware to implement the communication protocols. An accept thread AT is a thread which may be used by the disclosed embodiments of the invention for implementing the mechanism for establishing connections on demand.

All processes in the distributed application may take the roles of senders, receivers, or both, depending on the application algorithm. Each process may have one or more UT (depending on the application's design), one PT and one AT. PT and AT may be used by the communication middleware, PT and AT may be transparent to the user code and the interactions between UT, PT and AT may be handled internally by the middleware. Part of the code used by the embodiments of the invention may be executed by UT and PT.

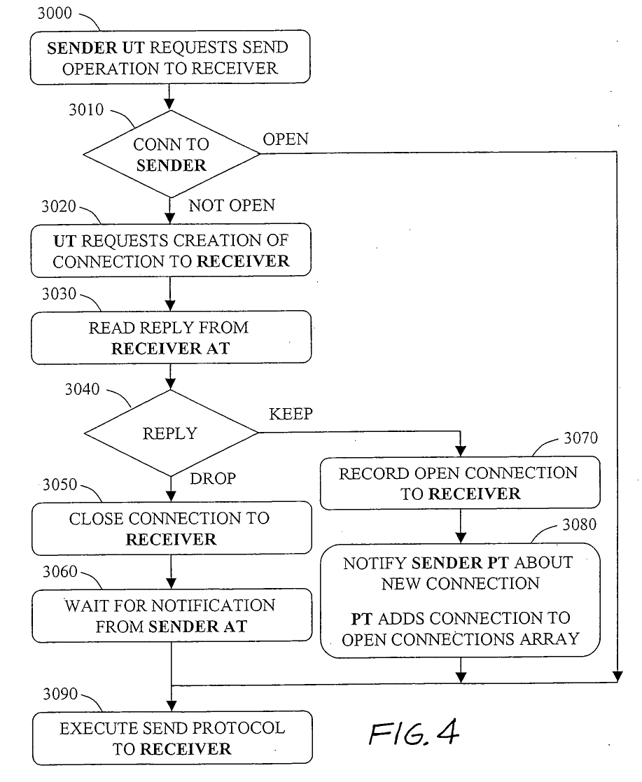

As shown in FIG. 4, there is shown the algorithm of the mechanism for connections-on-demand from the standpoint of the sender process.

When the UT requests a communication operation to a receiver process at box 3000, a check for the existence of an already created and opened connection to receiver is made at box 3010. If such connection exists, the communication protocol for transfer to peer receiver is invoked at box 3080. If the connection does not exist, a request for establishing a connection on demand to the receiver is issued and after the request succeeds, a connection to receiver is created at box 3020. Then, the UT waits for a reply from receiver's AT at box 3030. The reply can be either “KEEP” or “DROP” meaning that UT should either keep this newly established connection or disconnect it. In normal circumstances, the reply is “KEEP”. The “DROP” reply is used in rare situations when both communicating peers make simultaneous requests for establishing a connection between them. A “DROP” reply may be received during the send side of the protocol for connections on demand when the local AT of this process has received a request from the same peer after the protocol has been initiated. This situation leads to a race condition when the communicating peers are both sender and receiver processes. This race condition is resolved by the disclosed embodiments of the invention through the employment of an internal mechanism for serializing the admission of new connections. One of the requests for connections may be admitted first, thus making the second connection unnecessary.

If the check for the contents of the reply at box 3040 yields “KEEP”, the UT records the new connection as opened at box 3070 and notifies the progress thread PT about the newly established connection, in turn PT inserts the connection descriptors in the array for active connections at box 3080. From this moment forward, the connection is used for communication to receiver, for both sending and receiving operations with which the connections on demand protocol finishes and the requested send operation can be executed at box 3090.

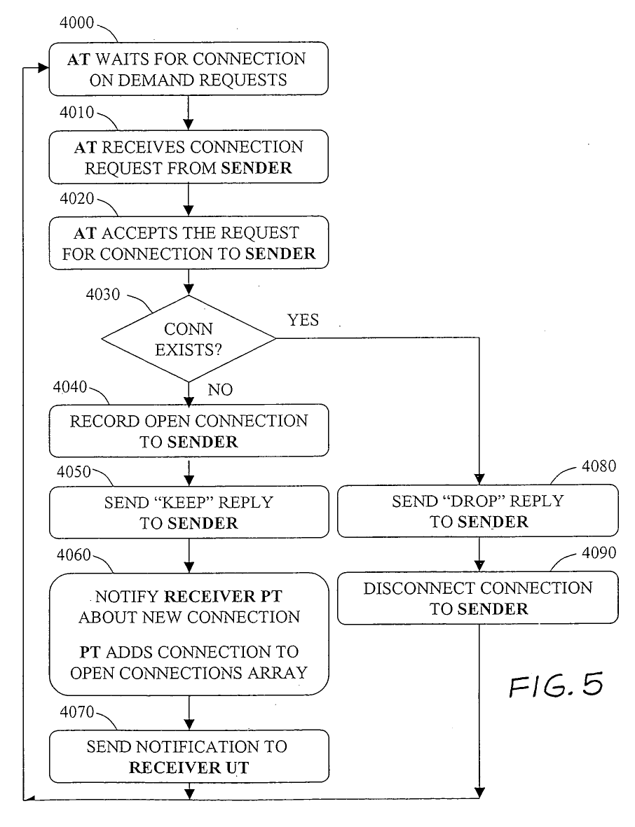

If the check for the contents of the reply at box 3040 yields “DROP”, then the connection to receiver is disconnected at box 3050 and the UT goes into a wait state expecting a notification from the local AT at box 3060. Since the newly opened connection was dropped in this branch of the protocol algorithm, an earlier request from the same peer receiver must have arrived and succeeded. After the admission of this earlier connection by the local AT, it needs to notify the PT about the new connection so that this new connection can be used for communication to peer receiver (see box 4060 in FIG. 5). Once AT completes the notification of PT about the new connection, AT signals UT (see at box 4070 in FIG. 5), which can then exit its wait state and continue with the transfer protocol of the requested send operation at box 3080.

As shown in FIG. 5, there is shown the algorithm of the mechanism for connections-on-demand from the standpoint of the receiver process.

The receive side of the connections on demand protocol is executed by the AT of the receiving process. AT may wait for requests for new connections on demand at box 4000. When a request arrives from sender process at box 4010, a new connection to sender is established at box 4020. Then, AT checks if the connection has already been established at box 4030. This connection may have been established only if the above described race conditions had occurred, with the send protocol of the UT being first to create the connection and record it as open. If the connection has been already established, AT sends a “DROP” reply to sender at box 4080, disconnects the connection to sender at box 4090, and goes into a wait state for a subsequent connection request at box 4000.

If the connection has not been established yet, AT records the connection as opened at box 4040 and sends a “KEEP” reply to the requesting sender at box 4050. Then, AT notifies PT about the newly created operation and PT in turn adds the new connection descriptor to the array of active connections at box 4060. AT sends a notification to UT that a new connection to sender has been created in case UT had simultaneously requested a connection to sender and is waiting on a signal from AT in order to continue (see at box 3060 in FIG. 4). After the UT is notified AT returns to its starting state to wait for new connections on demand requests at box 4000.

While particular embodiments of the present invention have been disclosed, it is to be understood that various different modifications are possible and are contemplated within the true spirit and scope of the appended claims. For example, the apparatus and method of the present invention may be implemented in a variety of different ways including techniques not employing threads. The method and apparatus may be used for suitable networks such as Fast Ethernet and Gigabit Ethernet. Also, they may be implemented in MPI COMMUNICATION MIDDLEWARE, but can be in any other peer-to-peer middleware. There is no intention, therefore, of limitations to the exact abstract or disclosure herein presented.

What is claimed is:

1. A method for establishing connections in a distributed computing system to execute a job having a group of processes, comprising
waiting for on demand connection requests by connection acceptors associated individually with each process;
determining if a connection is already established between a sender process and a receiver process;
requesting the creation of a new connection to the receiver process by the sender process if a connection is not already established between the sender process and the receiver process;
receiving the new connection on demand request by the connection acceptor associated with the receiver process;
establishing the requested new connection to facilitate the execution of processes; and
establishing thereafter other connections between other processes of the job.

2. A method as recited in claim 1, further including executing a protocol for a send operation to the receiver process.

3. A method as recited in claim 1, further including determining if the receiver process has initiated a connection to the sender process after it has been determined that a connection had not been established between the sender process and the receiver process.

4. A method as recited in claim 3, further including sending a signal from the receiver process indicating if the receiver process has already initiated a connection to the sender process.

5. A method as recited in claim 3, further including terminating the new connection to the receiver process if the receiver process has already initiated a connection to the sender process.

6. A method as recited in claim 5, further including waiting for a signal from the sender process that includes information about the new connection before executing a protocol for a send operation to the receiver process.

7. A method according to claim 3, further including
sending a signal to the sender process indicating that the receiver process has initiated a connection to the sender process; and
terminating the request for creation of a new connection to the receiver process.

8. A method as recited in claim 3, further including recording that the requested connection has been established if the receiver process has not already initiated a connection to the sender.

9. A method as recited in claim 8, further including notifying the sender process about the new connection between the sender process and the receiver process and adding an entry to an open connections array.

10. A method according to claim 3, further including
notifying the sending process of the already existing connection;
notifying the receiving process about the already existing connection; and
adding an entry to an open connections array.

11. A method according to claim 10, further including notifying a user thread of the already existing connection.

12. A method for establishing connections in a distributed computing system to execute a job having a group of processes, comprising
waiting for on demand connection requests by connection acceptors associated individually with each process;
receiving the new connection on demand request by the connection acceptor associated with the receiver process;
establishing the requested new connection to facilitate the execution of processes; and
establishing thereafter other connections between other processes of the job.

13. A method as recited in claim 12, further including determining if the receiver process has initiated a connection to the sender process after it has been determined that a connection had not been established between the sender process and the receiver process.

14. A method as recited in claim 13, further including sending a signal from the receiver process indicating if the receiver process has already initiated a connection to the sender process.

15. A method as recited in claim 13, further including terminating the new connection to the receiver process if the receiver process has already initiated a connection to the sender process.

16. A method according to claim 13, further including
sending a signal to a sender process indicating that the receiver process has initiated a connection to the sender process; and
terminating the request for creation of a new connection to the receiver process.

17. A method according to claim 13, further including
notifying a sending process of the already existing connection;
notifying the receiving process about the already existing connection; and
adding an entry to an open connections array.

18. A method according to claim 17, further including notifying a user thread of the already existing connection.

19. A method for establishing connections in a distributed computing system to execute a job having a group of processes, comprising
determining if a connection is already established between a sender process and a receiver process;
requesting the creation of a new connection to the receiver process by the sender process if a connection is not already established between the sender process and the receiver process;
establishing the requested new connection to facilitate the execution of processes; and
establishing thereafter other connections between other processes of the job.

20. A method as recited in claim 19, further including determining if the receiver process has initiated a connection to the sender process after it has been determined that a connection had not been established between the sender process and the receiver process.

21. A method as recited in claim 20, further including sending a signal from the receiver process indicating if the receiver process has already initiated a connection to the sender process.

22. A method as recited in claim 20, further including terminating the new connection to the receiver process if the receiver process has already initiated a connection to the sender process.

23. A method as recited in claim 22, further including waiting for a signal from the sender process that includes information about the new connection before executing a protocol for a send operation to the receiver process.

24. A method as recited in claim 20, further including recording that the requested connection has been established if the receiver process has not already initiated a connection to the sender.

25. A method as recited in claim 24, further including notifying the sender process about the new connection between the sender process and the receiver process and adding an entry to an open connections array.

26. A system for establishing connections in a distributed computing system to execute a job having a group of processes, comprising
means for waiting for on demand connection requests by connection acceptors associated individually with each process,
means for determining if a connection is already established between a sender process and a receiver process;
means for requesting the creation of a new connection to the receiver process by the sender process if a connection is not already established between the sender process and the receiver process;
means for receiving the new connection on demand request by the connection acceptor associated with the receiver process;
means for establishing the requested new connection to facilitate the execution of processes; and
means for establishing thereafter other connections between other processes of the job.

27. A system as recited in claim 26, further including means for executing a protocol for a send operation to the receiver process.

28. A system as recited in claim 26, further including means for determining if the receiver process has initiated a connection to the sender process after it has been determined that a connection had not been established between the sender process and the receiver process.

29. A system as recited in claim 28, further including means for sending a signal from the receiver process indicating if the receiver process has already initiated a connection to the sender process.

30. A system as recited in claim 28, further including means for terminating the new connection to the receiver process if the receiver process has already initiated a connection to the sender process.

31. A system as recited in claim 30, further including means for waiting for a signal from the sender process that includes information about the new connection before executing a protocol for a send operation to the receiver process.

32. A system according to claim 28, further including
means for sending a signal to the sender process indicating that the receiver process has initiated a connection to the sender process; and
means for terminating the request for creation of a new connection to the receiver process.

33. A system as recited in claim 28, further including means for recording that the requested connection has been established if the receiver process has not already initiated a connection to the sender.

34. A system as recited in claim 28, further including means for notifying the sender process about the new connection between the sender process and the receiver process and adding an entry to an open connections array.

35. A system according to claim 28, further including
means for notifying the sending process of the already existing connection;
means for notifying the receiving process about the already existing connection; and
means for adding an entry to an open connections array.

36. A system according to claim 35, further including means for notifying a user thread of the already existing connection.

37. A system for establishing connections in a distributed computing system to execute a job having a group of processes, comprising
means for waiting for on demand connection requests by connection acceptors associated individually with each process;
means for receiving the new connection on demand request by the connection acceptor associated with the receiver process;
means for establishing the requested new connection to facilitate the execution of processes; and
means for establishing thereafter other connections between other processes of the job.

38. A system as recited in claim 37, further including means for determining if the receiver process has initiated a connection to the sender process after it has been determined that a connection had not been established between the sender process and the receiver process.

39. A system as recited in claim 38, further including means for sending a signal from the receiver process indicating if the receiver process has already initiated a connection to the sender process.

40. A system as recited in claim 38, further including means for terminating the new connection to the receiver process if the receiver process has already initiated a connection to the sender process.

41. A system according to claim 38, further including
means for sending a signal to a sender process indicating that the receiver process has initiated a connection to the sender process; and
means for terminating the request for creation of a new connection to the receiver process.

42. A system according to claim 38, further including
means for notifying a sending process of the already existing connection;
means for notifying the receiving process about the already existing connection; and
means for adding an entry to an open connections array.

43. A system according to claim 42, further including means for notifying a user thread of the already existing connection.

44. A system for establishing connections in a distributed computing system to execute a job having a group of processes, comprising
means for determining if a connection is already established between a sender process and a receiver process;
means for requesting the creation of a new connection to the receiver process by the sender process if a connection is not already established between the sender process and the receiver process;
means for establishing the requested new connection to facilitate the execution of processes; and
means for establishing thereafter other connections between other processes of the job.

45. A system as recited in claim 44, further including means for determining if the receiver process has initiated a connection to the sender process after it has been determined that a connection had not been established between the sender process and the receiver process.

46. A system as recited in claim 45, further including means for generating a signal from the receiver process indicating if the receiver process has already initiated a connection to the sender process.

47. A system as recited in claim 45, further including means for terminating the new connection to the receiver process if the receiver process has already initiated a connection to the sender process.

48. A system as recited in claim 47, further including means for waiting for a signal from the sender process that includes information about the new connection before executing a protocol for a send operation to the receiver process.

49. A system as recited in claim 45, further including means for recording that the requested connection has been established if the receiver process has not already initiated a connection to the sender.

50. A system as recited in claim 49, further including means for notifying the sender process about the new connection between the sender process and the receiver process and adding an entry to an open connections array.

51. A system for establishing connections in a distributed computing system to execute a job having a group of processes, comprising
a module for waiting for on demand connection requests by connection acceptors associated individually with each process;
a module for determining if a connection is already established between a sender process and a receiver process;
a module for requesting the creation of a new connection to the receiver process by the sender process if a connection is not already established between the sender process and the receiver process;
a module for receiving the new connection on demand request by the connection acceptor associated with the receiver process;
a module for establishing the requested new connection to facilitate the execution of processes; and
a module for establishing thereafter other connections between other processes of the job.

52. A system as recited in claim 51, further including a module for executing a protocol for a send operation to the receiver process.

53. A system as recited in claim 51, further including a module for determining if the receiver process has initiated a connection to the sender process after it has been determined that a connection had not been established between the sender process and the receiver process.

54. A system as recited in claim 53, further including a module for sending a signal from the receiver process indicating if the receiver process has already initiated a connection to the sender process.

55. A system as recited in claim 53, further including a module for terminating the new connection to the receiver process if the receiver process has already initiated a connection to the sender process.

56. A system as recited in claim 55, further including a module for waiting for a signal from the sender process that includes information about the new connection before executing a protocol for a send operation to the receiver process.

57. A system according to claim 53, further including
a module for sending a signal to the sender process indicating that the receiver process has initiated a connection to the sender process; and
a module for terminating the request for creation of a new connection to the receiver process.

58. A system as recited in claim 53, further including a module for recording that the requested connection has been established if the receiver process has not already initiated a connection to the sender.

59. A system as recited in claim 58, further including a module for notifying the sender process about the new connection between the sender process and the receiver process and adding an entry to an open connections array.

60. A system according to claim 53, further including
a module for notifying the sending process of the already existing connection;
a module for notifying the receiving process about the already existing connection; and
a module for adding an entry to an open connections array.

61. A system according to claim 60, further including a module for notifying a user thread of the already existing connection.

62. A system for establishing connections in a distributed computing system to execute a job having a group of processes, comprising
a module for waiting for on demand connection requests by connection acceptors associated individually with each process;
a module for receiving the new connection on demand request by the connection acceptor associated with the receiver process;
a module for establishing the requested new connection to facilitate the execution of processes; and
a module for establishing thereafter other connections between other processes of the job.

63. A system as recited in claim 62, further including a module for determining if the receiver process has initiated a connection to the sender process after it has been determined that a connection had not been established between the sender process and the receiver process.

64. A system as recited in claim 63, further including a module for sending a signal from the receiver process indicating if the receiver process has already initiated a connection to the sender process.

65. A system as recited in claim 63, further including a module for terminating the new connection to the receiver process if the receiver process has already initiated a connection to the sender process.

66. A system according to claim 63, further including
a module for sending a signal to a sender process indicating that the receiver process has initiated a connection to the sender process; and
a module for terminating the request for creation of a new connection to the receiver process.

67. A system according to claim 63, further including
a module for notifying a sending process of the already existing connection;
a module for notifying the receiving process about the already existing connection; and
a module for adding an entry to an open connections array.

68. A system according to claim 67, further including a module for notifying a user thread of the already existing connection.

69. A system for establishing connections in a distributed computing system to execute a job having a group of processes, comprising
a module for determining if a connection is already established between a sender process and a receiver process;
a module for requesting the creation of a new connection to the receiver process by the sender process if a connection is not already established between the sender process and the receiver process;
a module for establishing the requested new connection to facilitate the execution of processes; and
a module for establishing thereafter other connections between other processes of the job.

70. A system as recited in claim 69, further including a module for determining if the receiver process has initiated a connection to the sender process after it has been determined that a connection had not been established between the sender process and the receiver process.

71. A system as recited in claim 70, further including a module for sending a signal from the receiver process indicating if the receiver process has already initiated a connection to the sender process.

72. A system as recited in claim 70, further including a module for terminating the new connection to the receiver process if the receiver process has already initiated a connection to the sender process.

73. A system as recited in claim 72, further including a module for waiting for a signal from the sender process that includes information about the new connection before executing a protocol for a send operation to the receiver process.

74. A system as recited in claim 70, further including a module for recording that the requested connection has been established if the receiver process has not already initiated a connection to the sender.

75. A system as recited in claim 74, further including a module for notifying the sender process about the new connection between the sender process and the receiver process and adding an entry to an open connections array.

76. A computer readable medium having stored thereon computer executable instructions for performing a method for establishing connections in a distributed computing system to execute a job having a group of processes, comprising
waiting for on demand connection requests by connection acceptors associated individually with each process;
determining if a connection is already established between a sender process and a receiver process;
requesting the creation of a new connection to the receiver process by the sender process if a connection is not already established between the sender process and the receiver process;
receiving the new connection on demand request by the connection acceptor associated with the receiver process;
establishing the requested new connection to facilitate the execution of processes; and
establishing thereafter other connections between other processes of the job.

77. A method as recited in claim 76, further including executing a protocol for a send operation to the receiver process.

78. A method as recited in claim 76, further including determining if the receiver process has initiated a connection to the sender process after it has been determined that a connection had not been established between the sender process and the receiver process.

79. A method as recited in claim 78, further including sending a signal from the receiver process indicating if the receiver process has already initiated a connection to the sender process.

80. A method as recited in claim 78, further including terminating the new connection to the receiver process if the receiver process has already initiated a connection to the sender process.

81. A method as recited in claim 80, further including waiting for a signal from the sender process that includes information about the new connection before executing a protocol for a send operation to the receiver process.

82. A method according to claim 78, further including
sending a signal to the sender process indicating that the receiver process has initiated a connection to the sender process; and
terminating the request for creation of a new connection to the receiver process.

83. A method as recited in claim 78, further including recording that the requested connection has been established if the receiver process has not already initiated a connection to the sender.

84. A method as recited in claim 83, further including notifying the sender process about the new connection between the sender process and the receiver process and adding an entry to an open connections array.

85. A method according to claim 78, further including
notifying the sending process of the already existing connection;
notifying the receiving process about the already existing connection; and
adding an entry to an open connections array.

86. A method according to claim 85, further including notifying a user thread of the already existing connection.

87. A computer readable medium having stored thereon computer executable instructions for performing a method for establishing connections in a distributed computing system to execute a job having a group of processes, comprising
waiting for on demand connection requests by connection acceptors associated individually with each process;
receiving the new connection on demand request by the connection acceptor associated with the receiver process;
establishing the requested new connection to facilitate the execution of processes; and
establishing thereafter other connections between other processes of the job.

88. A method as recited in claim 87, further including determining if the receiver process has initiated a connection to the sender process after it has been determined that a connection had not been established between the sender process and the receiver process.

89. A method as recited in claim 88, further including sending a signal from the receiver process indicating if the receiver process has already initiated a connection to the sender process.

90. A method as recited in claim 88, further including terminating the new connection to the receiver process if the receiver process has already initiated a connection to the sender process.

91. A method according to claim 88, further including
sending a signal to a sender process indicating that the receiver process has initiated a connection to the sender process; and
terminating the request for creation of a new connection to the receiver process.

92. A method according to claim 88, further including
notifying a sending process of the already existing connection;
notifying the receiving process about the already existing connection; and
adding an entry to an open connections array.

93. A method according to claim 92, further including notifying a user thread of the already existing connection.

94. A computer readable medium having stored thereon computer executable instructions for performing a method for establishing connections in a distributed computing system to execute a job having a group of processes, comprising
determining if a connection is already established between a sender process and a receiver process;
requesting the creation of a new connection to the receiver process by the sender process if a connection is not already established between the sender process and the receiver process;
establishing the requested new connection to facilitate the execution of processes; and
establishing thereafter other connections between other processes of the job.

95. A method as recited in claim 94, further including determining if the receiver process has initiated a connection to the sender process after it has been determined that a connection had not been established between the sender process and the receiver process.

96. A method as recited in claim 95, further including sending a signal from the receiver process indicating if the receiver process has already initiated a connection to the sender process.

97. A method as recited in claim 95, further including terminating the new connection to the receiver process if the receiver process has already initiated a connection to the sender process.

98. A method as recited in claim 97, further including waiting for a signal from the sender process that includes information about the new connection before executing a protocol for a send operation to the receiver process.

99. A method as recited in claim 95, further including recording that the requested connection has been established if the receiver process has not already initiated a connection to the sender.

100. A method as recited in claim 99, further including notifying the sender process about the new connection between the sender process and the receiver process and adding an entry to an open connections array.

101. An apparatus for establishing connections in a distributed computing system to execute a job having a group of processes, comprising
a processor for waiting for on demand connection requests by connection acceptors associated individually with each process;
a processor for determining if a connection is already established between a sender process and a receiver process;
a processor for requesting the creation of a new connection to the receiver process by the sender process if a connection is not already established between the sender process and the receiver process;
a processor for receiving the new connection on demand request by the connection acceptor associated with the receiver process;
a processor for establishing the requested new connection to facilitate the execution of processes; and
a processor for establishing thereafter other connections between other processes of the job.

102. The apparatus as recited in claim 101, further including a processor for executing a protocol for a send operation to the receiver process.

103. The apparatus as recited in claim 101, further including a processor for determining if the receiver process has initiated a connection to the sender process after it has been determined that a connection had not been established between the sender process and the receiver process.

104. The apparatus as recited in claim 103, further including a processor for sending a signal from the receiver process indicating if the receiver process has already initiated a connection to the sender process.

105. The apparatus as recited in claim 103, further including a processor for terminating the new connection to the receiver process if the receiver process has already initiated a connection to the sender process.

106. The apparatus as recited in claim 105, further including a processor for waiting for a signal from the sender process that includes information about the new connection before executing a protocol for a send operation to the receiver process.

107. The apparatus according to claim 103, further including
a processor for sending a signal to the sender process indicating that the receiver process has initiated a connection to the sender process; and
a processor for terminating the request for creation of a new connection to the receiver process.

108. The apparatus as recited in claim 103, further including a processor for recording that the requested connection has been established if the receiver process has not already initiated a connection to the sender.

109. The apparatus as recited in claim 108, further including a processor for notifying the sender process about the new connection between the sender process and the receiver process and adding an entry to an open connections array.

110. The apparatus according to claim 103, further including
a processor for notifying the sending process of the already existing connection;
a processor for notifying the receiving process about the already existing connection; and
a processor for adding an entry to an open connections array.

111. The apparatus according to claim 110, further including a processor for notifying a user thread of the already existing connection.

112. An apparatus for establishing connections in a distributed computing system to execute a job having a group of processes, comprising
a processor for waiting for on demand connection requests by connection acceptors associated individually with each process;
a processor for receiving the new connection on demand request by the connection acceptor associated with the receiver process;
a processor for establishing the requested new connection to facilitate the execution of processes; and
a processor for establishing thereafter other connections between other processes of the job.

113. The apparatus as recited in claim 112, further including a processor for determining if the receiver process has initiated a connection to the sender process after it has been determined that a connection had not been established between the sender process and the receiver process.

114. The apparatus as recited in claim 113, further including a processor for sending a signal from the receiver process indicating if the receiver process has already initiated a connection to the sender process.

115. The apparatus as recited in claim 113, further including a processor for terminating the new connection to the receiver process if the receiver process has already initiated a connection to the sender process.

116. The apparatus according to claim 113, further including
a processor for sending a signal to a sender process indicating that the receiver process has initiated a connection to the sender process; and
a processor for terminating the request for creation of a new connection to the receiver process.

117. The apparatus according to claim 113, further including
a processor for notifying a sending process of the already existing connection;
a processor for notifying the receiving process about the already existing connection; and
a processor for adding an entry to an open connections array.

118. The apparatus according to claim 117, further including a processor for notifying a user thread of the already existing connection.

119. An apparatus for establishing connections in a distributed computing system to execute a job having a group of processes, comprising
a processor for determining if a connection is already established between a sender process and a receiver process;
a processor for requesting the creation of a new connection to the receiver process by the sender process if a connection is not already established between the sender process and the receiver process;
a processor for establishing the requested new connection to facilitate the execution of processes; and
a processor for establishing thereafter other connections between other processes of the job.

120. The apparatus as recited in claim 119, further including a processor for determining if the receiver process has initiated a connection to the sender process after it has been determined that a connection had not been established between the sender process and the receiver process.

121. The apparatus as recited in claim 120, further including a processor for sending a signal from the receiver process indicating if the receiver process has already initiated a connection to the sender process.

122. The apparatus as recited in claim 120, further including a processor for terminating the new connection to the receiver process if the receiver process has already initiated a connection to the sender process.

123. The apparatus as recited in claim 122, further including a processor for waiting for a signal from the sender process that includes information about the new connection before executing a protocol for a send operation to the receiver process.

124. The apparatus as recited in claim 120, further including a processor for recording that the requested connection has been established if the receiver process has not already initiated a connection to the sender.

125. The apparatus as recited in claim 124, further including a processor for notifying the sender process about the new connection between the sender process and the receiver process and adding an entry to an open connections array.
